(19) United States
(12) Patent Application Publication
(10) Pub. No.: US 2003/0233244 A1
(43) Pub. Date: Dec. 18, 2003

(54) System and method for network tracking of passenger travel progress

(75) Inventor: David Bruce Kumhyr, Austin, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/171,944

(22) Filed: Jun. 13, 2002

(51) Int. Cl. G06F 17/60

(52) U.S. Cl. 705/1; 705/5

(57) ABSTRACT

A system and method for tracking passenger's air travel progress is provided. The passenger maintains a profile that includes a passenger identifier and notification information. The passenger tracking system uses the notification information in conjunction with data received from the FAA's ETMS to determine whether a notification should be provided as well as the information to include in the notification. The notification message can be sent to text-based communication addresses, such as email addresses, facsimile machines, and digital pagers as well as speech-based systems such as telephones. Additionally, flight information can be posted to a particular Internet web site or sent to one or more email addresses whenever the passenger is identified in a flight manifest. In this manner, an up to date itinerary is available with the most accurate information concerning the passenger's travel status. The system can be used to identify criminal suspects and coordinate their apprehension.

### BACKGROUND OF THE INVENTION

1. Technical Field

The present invention relates in general to a system and method for tracking the travel progress of passengers over a computer network. In particular, the present invention relates to a system and method for using flight databases for scheduled flights along with manifest data to determine a passenger's flight status as well as the ability to share and/or use such information.

2. Description of the Related Art

Modern air travel is increasingly complex due to the vast network of commercial airplanes traveling to thousands of cities to drop passengers off and pick them up. Coupled with this complexity are increased security measures that make it more difficult for passengers to get to boarding areas and more difficult for people waiting for passengers to pick them up. In many airports today, people who do not have tickets are not allowed to pass through security to wait for passengers. Most airports were designed before these tighter security measures were enacted and, therefore, have limited waiting areas outside the secure area.

Moreover, communications to and from passengers is difficult, especially when the passenger is on a commercial airline. Commercial airlines allow limited communication means because of risks associated with the airplane's navigation system. Passengers often have access to air-phones that are located on the back of passenger seats. A credit card is typically used in order to place calls from such air-phones. A challenge of using these phones, however, is that they are typically extremely expensive. This expense is exacerbated when a passenger would like to contact several people, such as those waiting for the passenger at the flight's destination as well as family members at home concerned about the passenger's safe arrival.

An additional challenge is that the passenger may not know how to get in contact with people that he would like to call using the air-phone. Furthermore, the passenger likely will not know if the flight plans and arrival information will change further, causing still more phone calls if further flight information is learned. Finally, passengers on board the plane are given limited information about the status of the flight. This information is usually only provided by the pilot and co-pilot at times using the plane's intercom at times that the pilots deem appropriate.

Receipt of limited information from the flight crew may not enable the passenger to convey meaningful curbside pickup information to people waiting to meet the passenger. In addition, weather conditions and heavy flight conditions may cause other flights in which the passenger is concerned, especially connecting flights. Because of the number of connecting flights, the flight crew often does not have or does not communicate the information to the passengers. The passenger often only determines the status of his connecting flights after disembarking the aircraft and checking airport monitors located in the secured area of the airport.

What is needed, therefore, is a system and method that notifies people of a passenger's travel status as the passenger travels by air. A system and method that allows the passenger to choose notification conditions, or triggers, along with various communication methods is needed so that the passenger and those interested in the passenger's whereabouts can keep informed of the passenger's flight status.

### SUMMARY

It has been discovered that the aforementioned challenges can be addressed by using a system and method that uses near-real time flight information to track a passenger's progress. Near-real time flight data is obtained through the Federal Aviation Administration's Enhanced Traffic Management System (the FAA's ETMS). The near-real time flight data is used in conjunction with passenger data, such as flight manifests, to detect flight conditions and notify the passenger, or people associated with the passenger, accordingly.

The passenger manages a profile that includes a passenger identifier, a password, and notification information. The passenger tracking system uses the notification information in conjunction with data received from the FAA's ETMS to determine whether a notification should be provided as well as the information to include in the notification. For example, a notification message for a passenger named John Doe might be: “FOR PASSENGER JOHN DOE—THE ETA FOR FLIGHT 555 FROM ATLANTA TO DALLAS HAS BEEN CHANGED FROM 6:00PM TO 6:35PM ON MONDAY JUN. 10, 2002.”

The notification message can be sent to text-based communication addresses, such as email addresses, facsimile machines, and digital pagers as well as speech-based systems such as telephones. In one embodiment, the air-phone located nearest the passenger is identified using flight data and the phone number corresponding to the nearby air-phone is retrieved. The retrieved phone number is called and an audible message is delivered when the passenger answers the air-phone. Additionally, flight information can be automatically posted to a particular Internet web site or sent to one or more email addresses whenever the passenger is identified in a flight manifest. In this manner, an up to date itinerary is available with the most accurate information concerning the passenger's expected arrival time.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a network diagram of a requester using a passenger tracking system;

FIG. 2 is a sample profile screen used by a passenger to control notifications and actions that occur while the passenger is traveling;

FIG. 3 is a flowchart for updating a passenger profile;

FIG. 4 is a flowchart for processing passenger notification requests;

FIG. 5 is a flowchart for processing a passenger notification action;

FIG. 6 is a flowchart for processing special passenger notification actions;

FIG. 7 is a flowchart for processing manifest actions;

FIG. 8 is a flowchart for a manifest rules thread used to handle a passenger's manifest rules;

FIG. 9 is a flowchart of law enforcement and airline security identification of individuals within flight manifests; and

FIG. 10 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

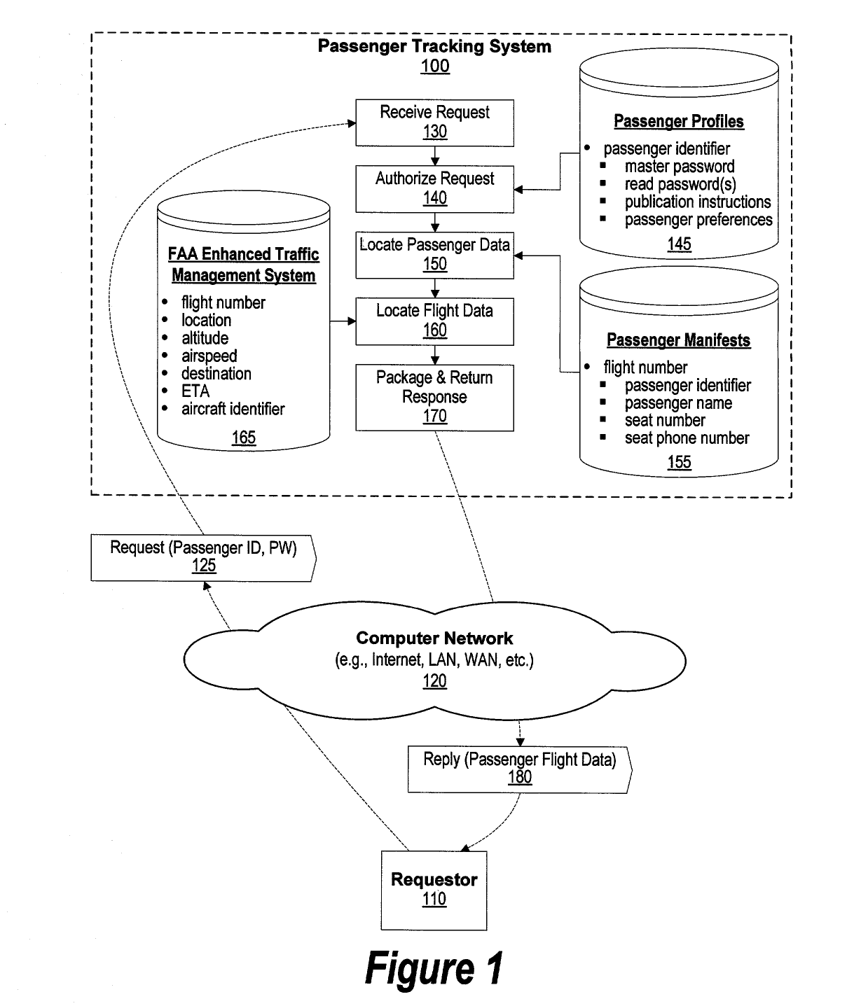

FIG. 1 is a network diagram of a requester using a passenger tracking system. Passenger tracking system 100 receives request 125 from requester 110 through computer network 120. Examples of computer network 120 include the Internet, a Local Area Network (LAN), a Wide Area Network (WAN), a wireless network (such as that used with mobile telephones and personal digital assistants (PDAs), an a telephone connection using a Public Switched Telephone Network (PSTN). Requestor 110 includes any device, such as a personal computer, a mobile telephone, a wireless PDA, that is able to communicate with computer network 120 using a network interface. Request 125 is an electronic message that is conveyed through computer network 120. As shown, the request may include a passenger identifier that identifies a particular passenger along with an authorization mechanism, such as a password, digital certificate, or other mechanism, that serves to authorize the requestor's ability to make the given request.

Passenger tracking system 100 receives the request (step 130). The system retrieves the identified passenger profile from passenger profiles data store 145. The system authorizes the request using the retrieved passenger profile (step 140). If the request is authorized, the system locates the identified passenger (step 150) using one or more flight manifests 155. If the identified passenger is found in one of the manifests, the flight data corresponding to the flight is located (step 160) from flight traffic data store 165. An example of flight traffic data store 165 is the FAA Enhanced Traffic Management System (ETMS) that includes flight data for all flights flying using “instrument flight rules” (IFR, i.e. the rules under which commercial airlines and most charter and corporate airlines operate).

If a flight for the identified passenger was located, data about the flight, such as its current position, estimated time of arrival, destination, etc., is retrieved and packaged. The packaged response, or reply, is sent back to the requester (step 170). Reply 180 is transmitted back to requester 110 through computer network 120.

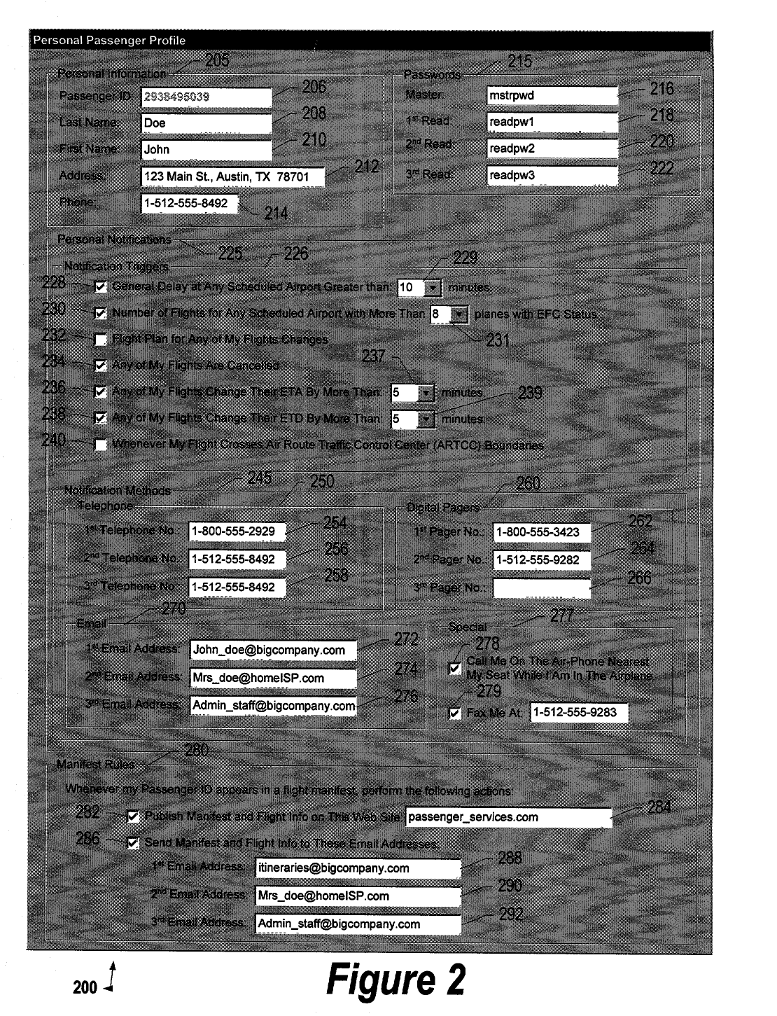

FIG. 2 is a sample profile screen used by a passenger to control notifications and actions that occur while the passenger is traveling. Profile screen 200 includes various types of data for sharing the passenger's flight information with others, notifying the passenger of flight changes, and sending the passenger's flight information to others, such as co-workers, family, and friends, based upon settings established by the passenger.

In the example shown in FIG. 2, passenger profile 200 includes personal information group 205, password group 215, personal notifications group 225, and manifest rules 280. Personal information 205 includes information about the passenger. This data includes the passenger's unique passenger identification number 206, the passenger's last name 208, the passenger's first name 210, the passenger's address 212, and the passenger's phone number 214. The passenger's unique identification number is shown as a protected field to prevent the passenger from accidentally changing his or her passenger ID.

Passwords group 215 includes one or more passwords that the passenger can set to control users that can access the passenger's data. In the example shown, master password 216 allows the holder of the master password to alter the user's profile. In addition, three “read” passwords are set (read passwords 218, 220, and 222), which allow the holders of these passwords to read passenger information, but does not allow the read password user to change the personal profile. For example, the passenger could provide his family with the first read password, his co-workers with the second read password, and his friends with the third read password. In this fashion, if the passenger changed jobs, he could change the second read password for his new co-workers and leave the other two read passwords unchanged.

Personal notifications group 225 includes notification triggers group 226 and notification methods group 245. Notifications triggers group 226 includes a number of “triggers” that, when they occur, cause a notification to be sent according to the defined notification methods. In the profile shown, notification triggers include checkbox 228 which, when selected, will cause a notification whenever the general delay at any of the passenger's scheduled airports is greater than a certain number of minutes. Combo box 229 is used to select the number of delay minutes that triggers the notification. Checkbox 230 will, when selected, cause a notification to be sent when the number of flights for any of the passenger's scheduled airports has a certain number of airplanes with an Expect Further Clearance (EFC) status (i.e. EFC status may indicate that such aircraft are in holding patterns and that the airport is becoming contested). Combo box 231 is used to choose the number of airplanes with EFC status.

Checkbox 232, when selected, causes a notification to be triggered when the flight plan for any of the passenger's scheduled flights changes, while checkbox 234 causes a notification when any of the passenger's flights are cancelled. Checkboxes 236 and 238 deal with expected delays in the passenger's flights. Checkbox 236 causes a notification when any flight's Estimated Time of Arrival (ETA) changes by more than a certain amount of time, while checkbox 238 causes a notification when any flight's Estimated Time of Departure (ETD) changes by more than a certain amount of time. Combo box 237 is used to select the number of minutes for the ETA trigger, while combo box 239 is used to select the number of minutes for the ETD trigger. Finally, check box 240 is used to provide a notification when the passenger's flight crosses Air Route Traffic Control Center (ARTCC) boundaries so that the passenger's progress can be tracked from one ARTCC to the next. In addition, more complex rules could be used to perform certain actions on the passenger's behalf. For example, profile information could be provided so that a hotel room is automatically booked, at one of the passenger's preferred hotels, in the event that the passenger's flight is delayed more than a certain amount of time and if attempts to book alternative flights have failed.

Notification methods group 245 include various methods by which the passenger, or someone else, can be notified when one of the selected notification triggers occurs. In the example shown, notification methods are broken into telephone methods 250, pager methods 260, email methods 270, and special methods 277. Telephone methods 250 includes three telephone numbers (text box 254, 256, and 258) that can be provided by the user. When a notification trigger occurs, the provided telephone numbers are called and an audio message is transmitted with information concerning the notification trigger (e.g., an audio message is played informing the receiver that the passenger's estimated time of arrival has changed so that a person waiting to pick up the passenger knows when to expect the arrival).

Pager methods 260 work similarly to the telephone methods except that a digital message is sent to the pager(s) informing the receiver regarding the notification trigger. Pager text boxes 262, 264, and 266 are used to provide pager numbers to which the message is transmitted.

Email methods 270 are used to send an email message to various email accounts informing the recipients that a notification trigger occurred along with the details concerning the trigger. Three email entries are provided (text boxes 272, 274, and 276). The notification message will be sent to any email address found in any of the email text boxes. For example, one message could be to the user so that the user can receive updated flight information using a portable computing device. Another email message could be to the passenger's spouse so that the spouse, while a third email message could be sent to the administrative staff at the passenger's work place.

Special methods 277 include check box 278 and check box 279. Check box 278, when selected, causes message to be delivered to a phone in the airplane in which the passenger is currently traveling (i.e. the nearest air phone typically located in the back of one of the seats in the row in front of the passenger). Check box 279 is another special method that, when selected, causes a facsimile message to be sent to a fax machine corresponding to a given phone number.

Manifest rules 280 include actions that are taken whenever the passenger's passenger identification number appears in a flight manifest. Check box 282, when selected, causes the passenger's manifest information (e.g., flight number, seat number, phone number for air-phone nearest the passenger, etc.) and flight information (e.g., departure airport, destination airport, ETA, ETD, current position) to be published to a particular Internet web site (text box 284). Check box 286, when selected, causes the manifest and flight information to be sent to a number of email addresses (text boxes 288, 292, and 294). In this manner, the passenger's co-workers and family can receive email messages that indicate the passenger's travel status. If the passenger's flight is delayed or otherwise disrupted, the recipients receive notification regarding the disruption without needing to call the airport or airline and without the passenger needing to telephone the individuals.

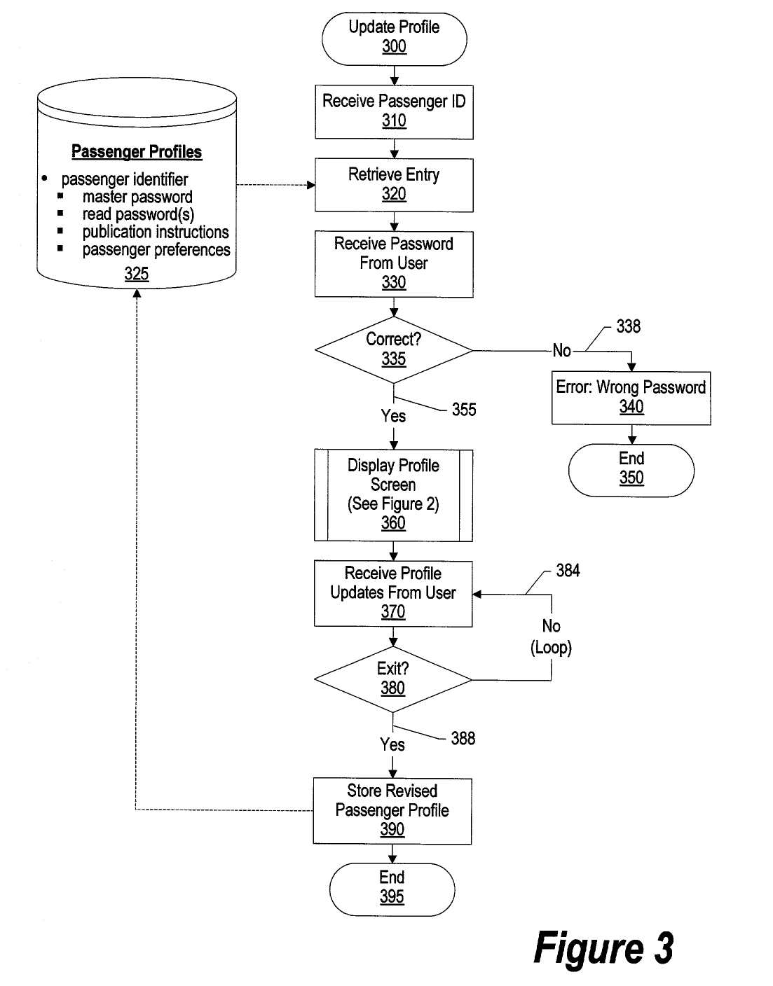

FIG. 3 is a flowchart for updating a passenger profile. Processing commences at 300 whereupon a passenger identification number is received at step 310. The passenger profile corresponding to the received passenger identification number is retrieved (step 325) from passenger profiles data store 325 (the passenger profile data store includes data similar to that shown in FIG. 2 for each passenger that has a profile).

A password is received from the user that is attempting to access the passenger profile (step 330). A determination is made as to whether the password matches one of the valid passwords that can be used to change the passenger profile (decision 335, see FIG. 2 for examples of passwords). If the password is not correct, decision 335 branches to “no” branch 338 whereupon an error is returned to the user (step 340) and processing ends at 350. On the other hand, if the password is correct decision 335 branches to “yes” branch 355 whereupon the profile screen is displayed to the user (step 360, see FIG. 2 for an example user profile screen).

Profile updates are received from the user (step 370). A determination is made as to whether the user would like to exit the profile and save the profile updates (decision 380). If the user is not ready to exit, decision 380 branches to “no” branch 384 which loops back to process the next profile updates. On the other hand, if the user is ready to exit the profile display screen and save the profile updates, decision 380 branches to “yes” branch 388 whereupon the profile updates are stored (step 390) in passenger profile data store 325. Processing subsequently ends at 395.

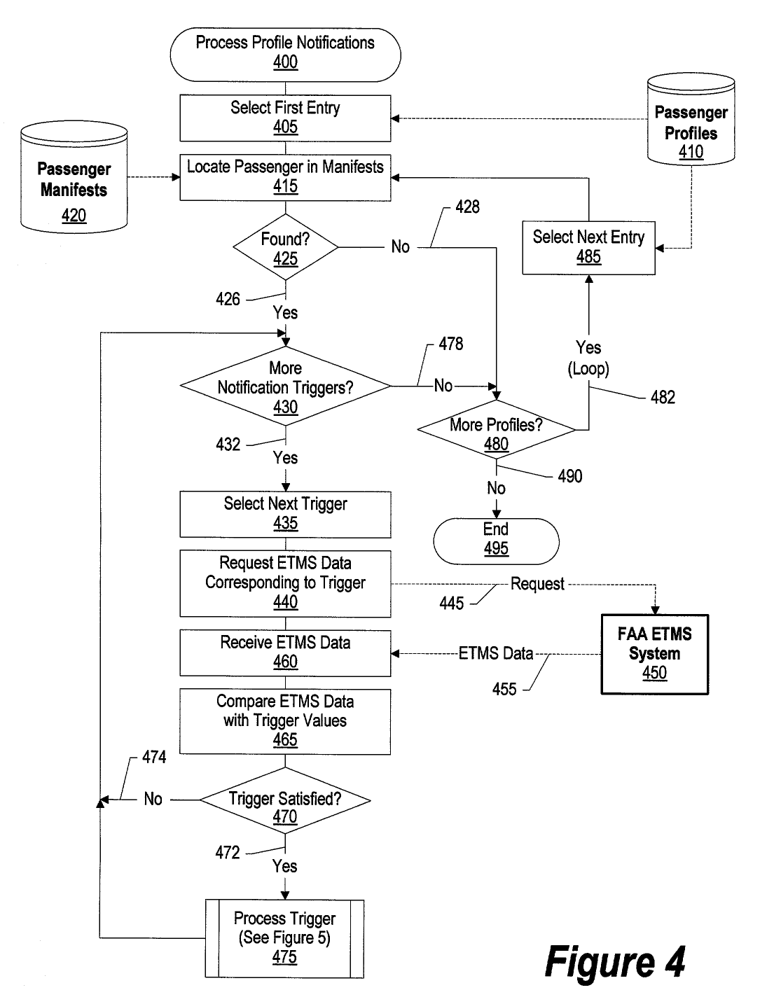

FIG. 4 is a flowchart for processing passenger notification requests (see FIG. 2, group 225 for examples of notification triggers and methods that can be used in notification requests). Processing commences at 400 whereupon a first notification entry is selected (step 405) from the selected passenger profile 410. The passenger is located (step 415) in one or more passenger manifests 420 that include information about the passengers flying and scheduled to fly on various airplanes. An example of a manifest is the passenger list for a particular commercial airline flight, typically grouped by flight number.

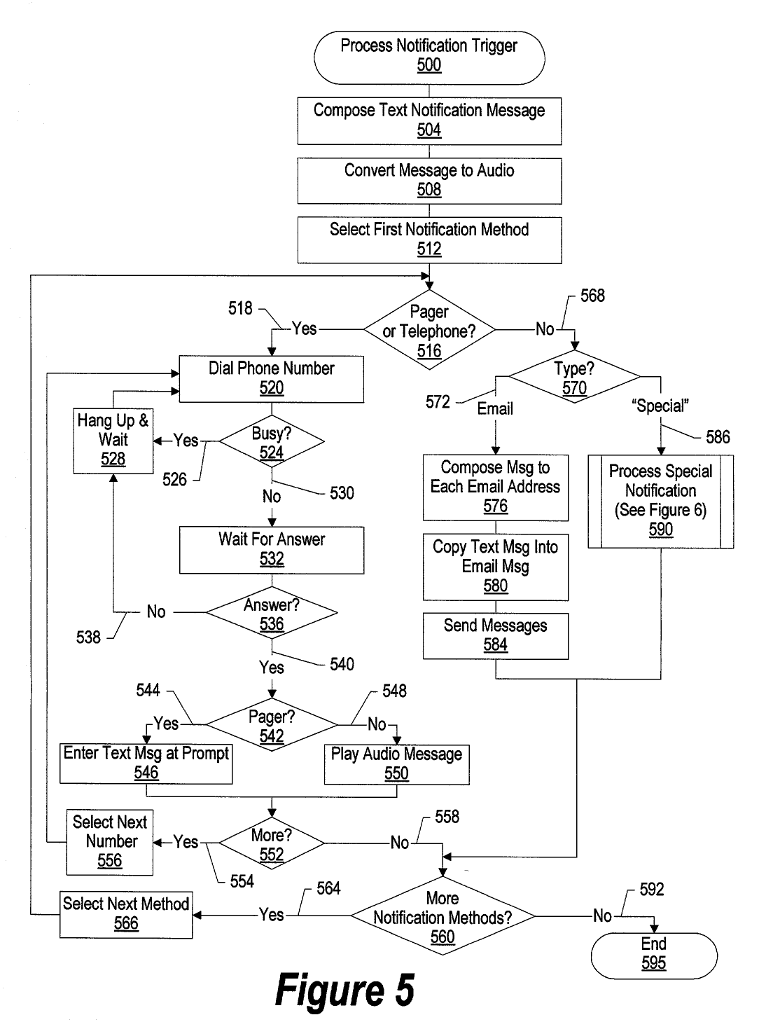

A determination is made as to whether the selected passenger is found in any of the manifests (decision 425). If the passenger was found, decision 425 branches to “yes” branch 426 whereupon a determination is made as to whether there are any notification triggers in the selected passenger's passenger profile (decision 430). If there are notification triggers, decision 430 branches to “yes” branch 432 to process the first notification trigger (step 435). Data regarding the flight(s) on which the passenger is traveling is maintained by a service, such as the Federal Aviation Administration's (FAA's) Enhanced Traffic Management System (ETMS). The flight data corresponding to the notification trigger is requested (step 440) by sending request 445 to ETMS 450. The ETMS responds with ETMS data 455 which is received at step 460. The received data is compared with the passenger's trigger values set in the passenger's profile that cause a notification event to occur (step 465). For example, if the passenger has a notification trigger to cause a notification to be sent if the passenger's estimated time of arrival (ETA) is changed by more than five minutes and the ETMS data indicates that the ETA of one of the passenger's flights has changed by more than five minutes, then the passenger's notification methods are processed in order to notify the passenger and/or his colleagues/family/friends of the change. A determination is made, as described above, as to whether the notification trigger has been satisfied (decision 470). If the trigger has been satisfied, decision 470 branches to “yes” branch 472 whereupon the trigger is processed (predefined process 475, see FIG. 5 for processing details) and processing loops back to process the next notification trigger. On the other hand, if the trigger condition is not satisfied, decision 470 branches to “no” branch 474 whereupon the trigger is not processed and processing loops back to process the next notification trigger.

Returning to decision 430, if there are no more notification triggers to process, decision 430 branches to “no” branch 478 whereupon a determination is made as to whether there are additional passenger profiles to process (decision 480). If there are additional passenger profiles to process, decision 480 branches to “yes” branch 482 which loops back to select the next passenger profile (step 485) from passenger profiles 410 and locate the next passenger profile (step 415) in flight manifests 420. If the passenger is not found, decision 425 branches to “no” branch 428 which again determines whether there are more passenger profiles to process (decision 480). The looping to process additional passenger profiles continues until there are no more profiles to process, at which point decision 480 branches to “no” branch 490 and processing ends at 495.

FIG. 5 is a flowchart for processing a passenger notification action. This processing is called from FIG. 4 when a notification trigger event has been detected and an appropriate notification needs to be sent to the passenger.

Processing commences at 500 whereupon a text based notification message is composed based upon the notification trigger that has been satisfied (step 504). For example, if a message is being composed because the ETA of one of the passenger's flights has been changed by more than an amount specified by the passenger, a message such as: “FOR PASSENGER JOHN DOE—THE ETA FOR FLIGHT 555 FROM ATLANTA TO DALLAS HAS BEEN CHANGED FROM 6:00PM TO 6:35PM ON MONDAY JUN. 10, 2002.” The text message is also converted to an audio message file using appropriate text translation tools such as IBM's Via VoiceT™ software (step 508). The first notification method is selected (step 512) from the passenger's profile (see FIG. 2, group 245 for examples of various notification methods).

A determination is made as to whether the notification method is either a pager or telephone method (decision 516). If the method is a pager or telephone notification, decision 516 branches to “yes” branch 518 whereupon the telephone number in the passenger's profile is dialed (step 520). A determination is made as to whether the dialed phone is busy (decision 524). If the phone is busy, decision 524 branches to “yes” branch 528 whereupon the connection is terminated and processing waits for a certain amount of time before dialing the phone number again (step 528). This looping continues until the phone is not busy, at which point decision 524 branches to “no” branch 530 whereupon processing waits for a human or answering machine to answer the phone (step 532). A determination is made as to whether the phone is answered (step 536). If there is no answer, decision 536 branches to “no” branch 538 which terminates the connection and waits a certain amount of time before dialing the phone number again (step 538). This looping continues until there is an answer, at which point decision 536 branches to “yes” branch 540 whereupon a determination is made as to whether the phone number is for a digital pager or a voice telephone (decision 542). If the phone number corresponds to a pager, decision 542 branches to “yes” branch whereupon the text message is entered at the prompt provided by the paging service (step 546). On the other hand, if the phone number is a voice telephone then decision 542 branches to “no” branch 548 whereupon the audio message is played to the receiver (step 550).

A determination is made as to whether there are additional pagers and/or telephone numbers to call for notification (decision 552). If there are other pagers and/or telephone numbers to call, decision 552 branches to “yes” branch 554 whereupon the next pager/telephone number is selected (step 556) from the passenger profile, and processing loops back to process the next number. This looping continues until there are no more pager/telephone numbers to process, at which point decision 552 branches to “no” branch 552 whereupon a determination is made as to whether there are more notification methods to process (decision 560). If there are more notification methods to process, decision 560 branches to “yes” branch 564 whereupon the next notification method is selected (step 566) and processing loops back to process the next notification method.

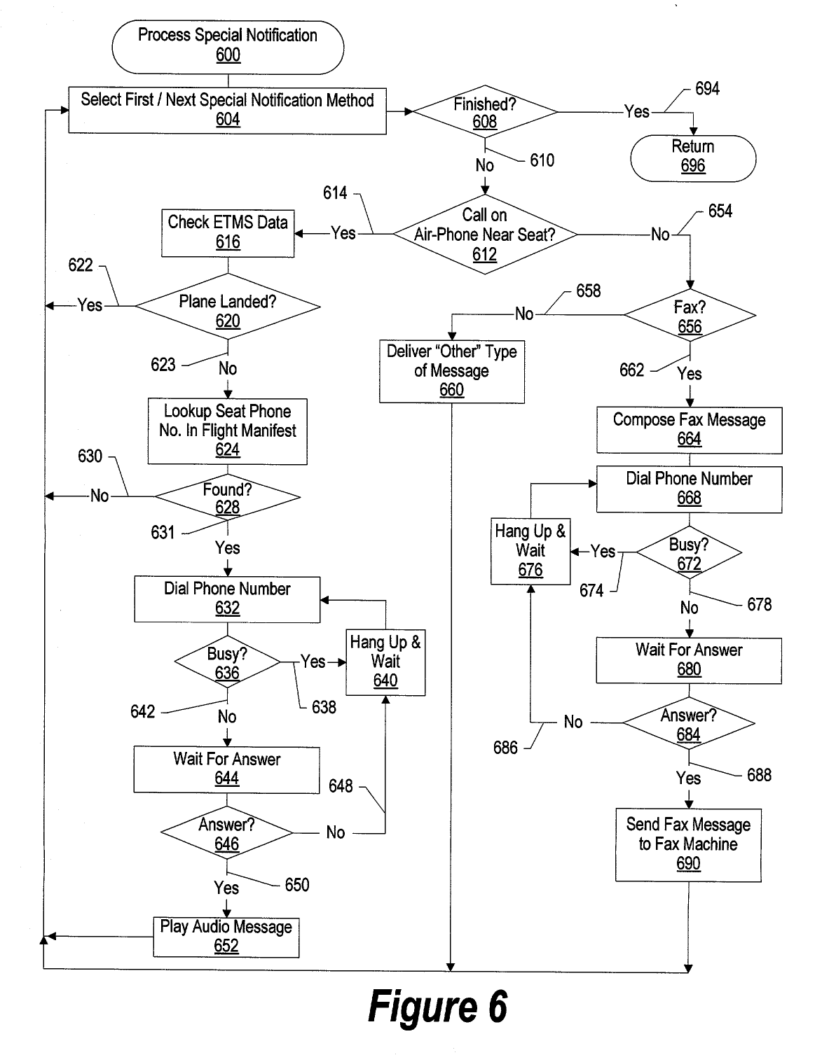

Returning to decision 516, if the notification method is not a pager or telephone notification, decision 516 branches to “no” branch 568 whereupon a determination is made as to the type of the notification method (decision 570). If the notification method is an email notification, decision 570 branches to “email” branch 572 whereupon an email message is composed to each addressee found in the passenger's profile (step 576), the text notification message is copied into the email message (step 580), and the message is sent to the addresse(es) (step 584). On the other hand, if the notification method is a special notification type, decision 570 branches to “special” branch 586 whereupon the special notification is processed (predefined process 590, see FIG. 6 for processing details).

After the non-pager/telephone method(s) are processed, decision 560 is processed. Processing continues to loop back to handle further notification methods until there are no more notification methods to process, at which point decision 560 branches to “no” branch 592 and processing ends at 595.

FIG. 6 is a flowchart for processing special passenger notification actions. This process is called from FIG. 5 when a “special” notification method is requested in a passenger's profile.

Processing commences at 600 whereupon the first special notification method is selected from the passenger's profile (step 604). A determination is made as to whether special notification processing is finished (decision 608, i.e. there are no more special notification methods to process). If special notification processing is not finished, decision 608 branches to “no” branch 610 whereupon a determination is made as to whether the special notification method is to call the passenger on the air-phone nearest the passenger's seat (decision 612).

If the special notification is to call the passenger on the nearest air-phone, decision 612 branches to “yes” branch 614 whereupon the ETMS data concerning the flight the passenger is on is checked (step 616). This data is used to determine whether the plane on which the passenger is flying has already landed (decision 620). If the plane has landed (i.e. the passenger will not be able to be reached using the air-phone), decision 620 branches to “yes” branch 622 which loops back to select and process the next special notification method. On the other hand, if the passenger's flight has not yet landed, decision 620 branches to “no” branch 623 whereupon the passenger's seat number is retrieved from the flight manifest data corresponding to the flight. A determination is made as to whether the phone number for the air-phone nearest the passenger was located in the manifest data (decision 628). If the air-phone data was not found, decision 628 branches to “no” branch 630 whereupon processing loops back to select and process the next special notification method.

On the other hand, if the phone number for the air-phone nearest the passenger's seat was found, decision 628 branches to “yes” branch 631 whereupon the phone number is dialed (step 632). A determination is made as to whether the air-phone is busy (decision 636). If the phone is busy, decision 636 branches to “yes” branch 638 whereupon the connection is terminated and processing waits for a certain amount of time before dialing the phone number again (step 640). This looping continues until the phone is not busy, at which point decision 636 branches to “no” branch 642 whereupon processing waits for someone to answer the phone (step 644). A determination is made as to whether the phone is answered (step 646). If there is no answer, decision 646 branches to “no” branch 648 which terminates the connection and waits a certain amount of time before dialing the phone number again (step 640). This looping continues until there is an answer, at which point decision 646 branches to “yes” branch 650 whereupon the audio message is played to the receiver (step 652).

Returning to decision 612, if the special notification is not to call the passenger on a nearby air-phone, decision 612 branches to “no” branch 654 whereupon a determination is made as to whether the special notification is for a facsimile message to be sent to one or more fax machines (decision 656). If the notification is not for a facsimile message, decision 656 branches to “no” branch 660 whereupon another “special” notification method is used to deliver the message (step 660).

On the other hand, if the notification method is a facsimile message, decision 656 branches to “yes” branch 662 whereupon a facsimile message is composed based upon the text notification message (step 664, see FIG. 5, step 504 for the composition of the text notification message) The phone number corresponding to the fax machine is dialed (step 668). A determination is made as to whether the fax machine's phone line is busy (decision 672). If the phone line is busy, decision 672 branches to “yes” branch 674 whereupon the connection is terminated and processing waits for a certain amount of time before dialing the phone number again (step 676). This looping continues until the phone is not busy, at which point decision 672 branches to “no” branch 678 whereupon processing waits for the fax machine to answer the phone (step 680). A determination is made as to whether the fax machine answered the phone (step 684). If there is no answer, decision 684 branches to “no” branch 686 which terminates the connection and waits a certain amount of time before dialing the phone number again (step 676). This looping continues until there is an answer, at which point decision 684 branches to “yes” branch 688 whereupon the facsimile message is transmitted to the fax machine (step 690). Processing then loops back to process the next special notification method.

Returning to decision 608, when all special notification methods have been processed, decision 608 branches to “yes” branch 694 whereupon processing returns at 696 (see FIG. 5 for subsequent processing steps).

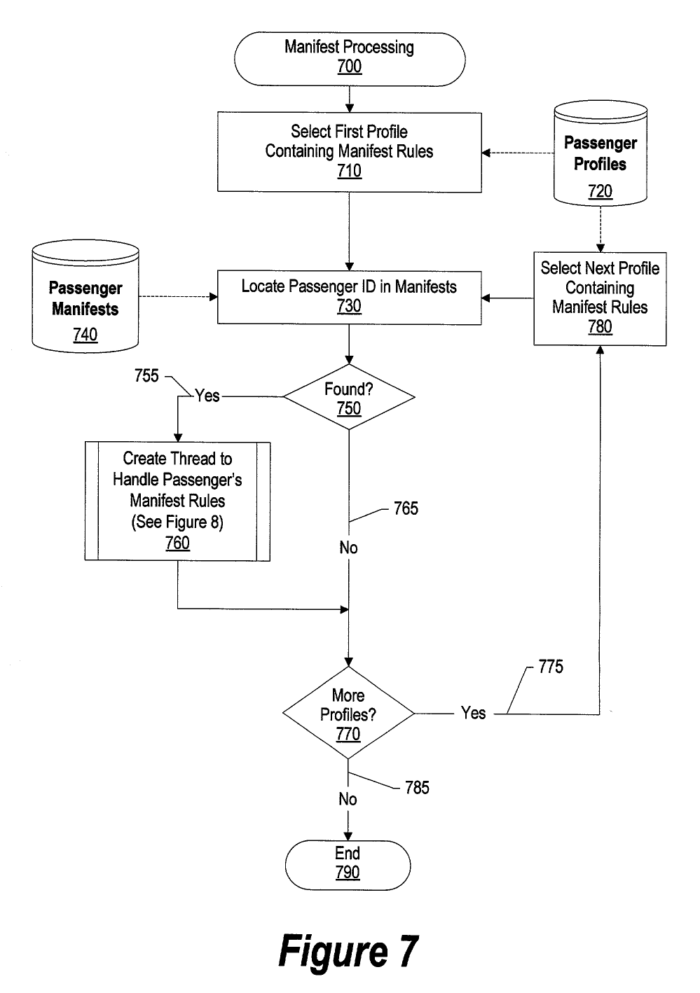

FIG. 7 is a flowchart for processing manifest actions. Manifest rules can be used to track a passenger's progress through various airplanes and airports. In this manner, people, such as the passenger, the passenger's colleagues and family, etc., are notified as the passenger travels throughout the air traffic system.

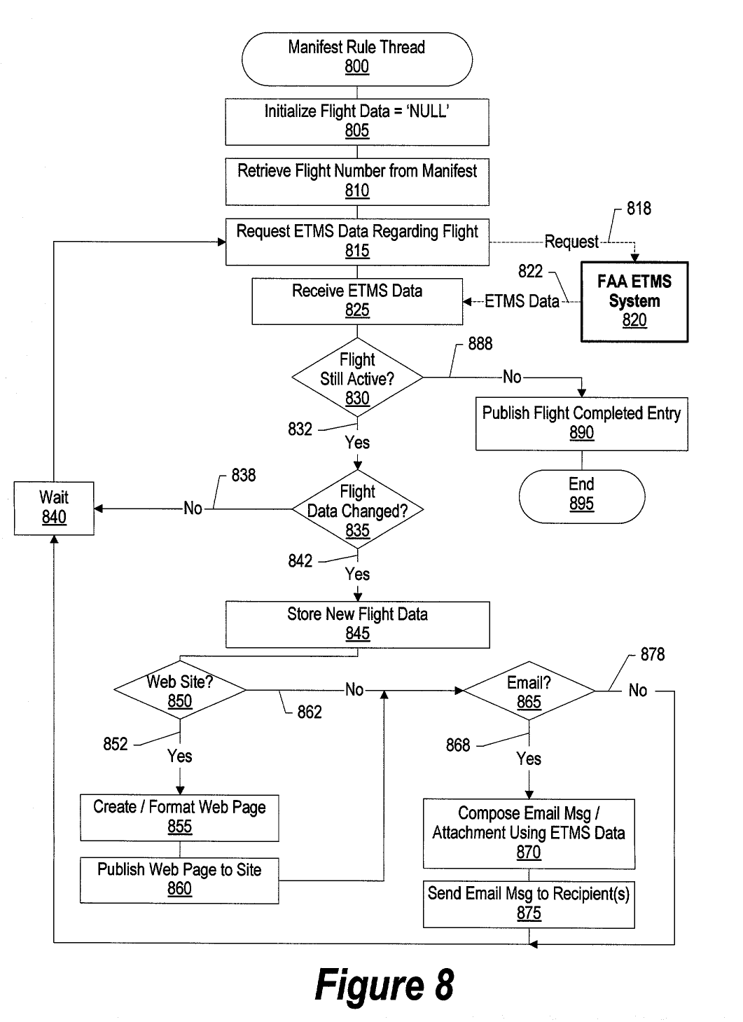

Processing commences at 700 whereupon the first profile entry for a passenger with manifest rules is selected (step 710) from passenger profiles data store 720. The passenger is located (step 730), by searching for the passenger's identification number in one or more flight manifest data stores 740. A determination is made as to whether the passenger's identification number was found (decision 750). If the passenger was found, decision 750 branches to “yes” branch 755 whereupon a thread is created to handle the passenger's manifest rules (predefined process 760, see FIG. 8 for processing details). On the other hand, if the passenger's ID is not found, decision 750 branches to “no” branch 765 and a thread is not created to handle the passenger's manifest rules.

A determination is made as to whether there are more profiles to process (decision 770). If there are more profiles to process, decision 770 branches to “yes” branch 775 whereupon processing loops back to select the next passenger profile that includes manifest rules (step 780) and process such manifest rules. This looping continues until there are no more passenger profiles with manifest rules, at which point decision 770 branches to “no” branch 785 and processing ends at 790.

FIG. 8 is a flowchart for a manifest rules thread used to handle a passenger's manifest rules. The rules thread is created and called from FIG. 7 which processes manifest rules for a group of passengers. A thread is created for each passenger that has manifest rules and is identified in a flight manifest in order to track the passenger's progress through the air traffic system.

Processing commences at 800 whereupon the passenger's current flight data is initialized to NULL (step 805). The passenger's current flight number is retrieved from the flight manifest data store (step 810). An ETMS request is made for data regarding the passenger's current flight (step 815) by sending ETMS request 818 to the ETMS system 820. Responsive ETMS data 822 is received at step 825.

A determination is made as to whether the flight is still active (decision 830). If the flight is still active, decision 830 branches to “yes” branch 832 whereupon a determination is made as to whether the flight's data is changed (decision 835). The flight's data includes whether the flight is delayed, whether the flight's flight plan has been changed, whether the flight has been cancelled or changed its ETA or ETD, and whether the flight has crossed air route traffic control center (ARTCC) boundaries). This determination is made by comparing the data received from the ETMS system with the data previously received from the ETMS system. If the data has not changed, decision 835 branches to “no” branch 838 whereupon processing waits for a period of time (step 840) before requesting a new set of ETMS data. On the other hand, if the flight data has been changed, decision 835 branches to “yes” branch 842 whereupon the new flight data is stored (step 845).

A determination is made as to whether the passenger has requested that the changed flight data should be posted to a web site (decision 850). If the passenger has requested that flight data be posted to a web site, decision then decision 850 branches to “yes” branch 852 whereupon a web page (or portion thereof) is created and formatted including the passenger's flight data (step 855) and the web page is published (step 860) so that Internet users with access to the web site can view the data. On the other hand, if the passenger has not requested that the data be posted to a web site, decision 850 branches to “no” branch 862 bypassing the web page creation and publication.

The web site to which the data is published can be secured so that only the passenger and other authorized users, such as the passenger's family, colleagues, and friends, are able to view the data. The security can be provided having the users enter a user name and password in order to access the web site or the passenger's travel information.

A determination is made as to whether the passenger has requested that the changed flight data be sent as an email message to one or more email recipients (decision 865). If the passenger has requested that flight data be sent to one or more email recipients, then decision 865 branches to “yes” branch 868 whereupon an email message is composed using the new flight data received from the ETMS system (step 870) and the messages are sent to one or more predefined recipients (step 875). On the other hand, if the passenger has not requested that the data be sent to one or more email recipients, decision 865 branches to “no” branch 878 bypassing the email creation and transmission.

Processing waits for a predetermined time period (step 840) before looping back to request further ETMS data and determining whether the passenger's flight data has changed. This looping continues until the flight is no longer active, at which point, decision 830 branches to “no” branch 888 whereupon “flight completed” messages are posted to the web site and/or email addresses (as described above) and thread processing ends at 895.

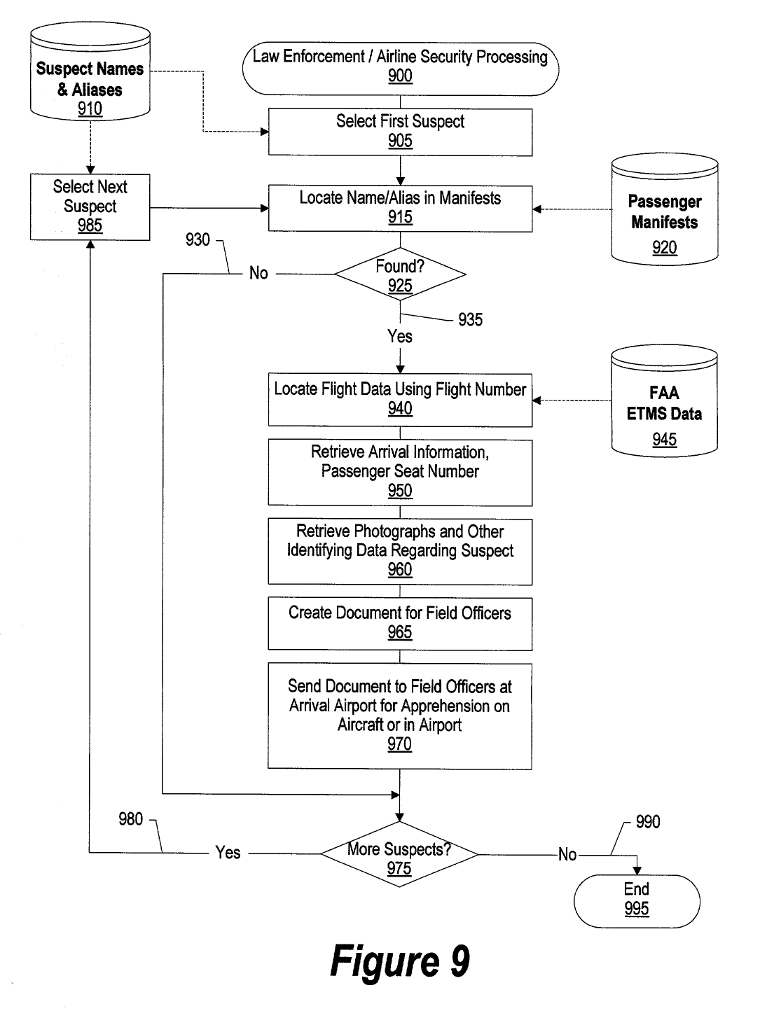

FIG. 9 is a flowchart of law enforcement and airline security identification of individuals within flight manifests. Processing commences at 900 whereupon a first suspect's name/alias is retrieved (step 905) from a suspect name and alias data store 910. The retrieve suspect name/alias is located (step 915) in one or more passenger manifest data stores 920 that include passenger lists for scheduled flights.

A determination is made as to whether the suspect's name/alias was found in the flight manifests (decision 925). If the suspect's name/alias was not found, decision 925 branches to “no” branch 930 which bypasses further processing of the suspect. On the other hand, if the suspect's name/alias was found, decision 925 branches to “yes” branch 935 whereupon the flight data for the suspect's flight is retrieved (step 940) from ETMS data store 945. The flight's arrival information is retrieved from the ETMS data along with the suspect's seat information from the flight's manifest (step 950). Photographs and other identifying information corresponding to the suspect are retrieved regarding the suspect (step 960). The flight information, suspect seat location, and identification information are used to create electronic documents for field officers to use in apprehending the suspect (step 965). The electronic documents are sent to field officers stationed at or near the arrival airport for apprehension of the suspect on the airplane or in the airport (step 970).

A determination is made as to whether there are additional suspects to search for in flight manifests (decision 975). If there are additional suspects, decision 975 branches to “yes” branch 980 which loops back to select the next suspect name/alias (step 985) and process the next suspect. This looping continues until there are no more suspects to process, at which time decision 975 branches to “no” branch 990 and processing ends at 995.

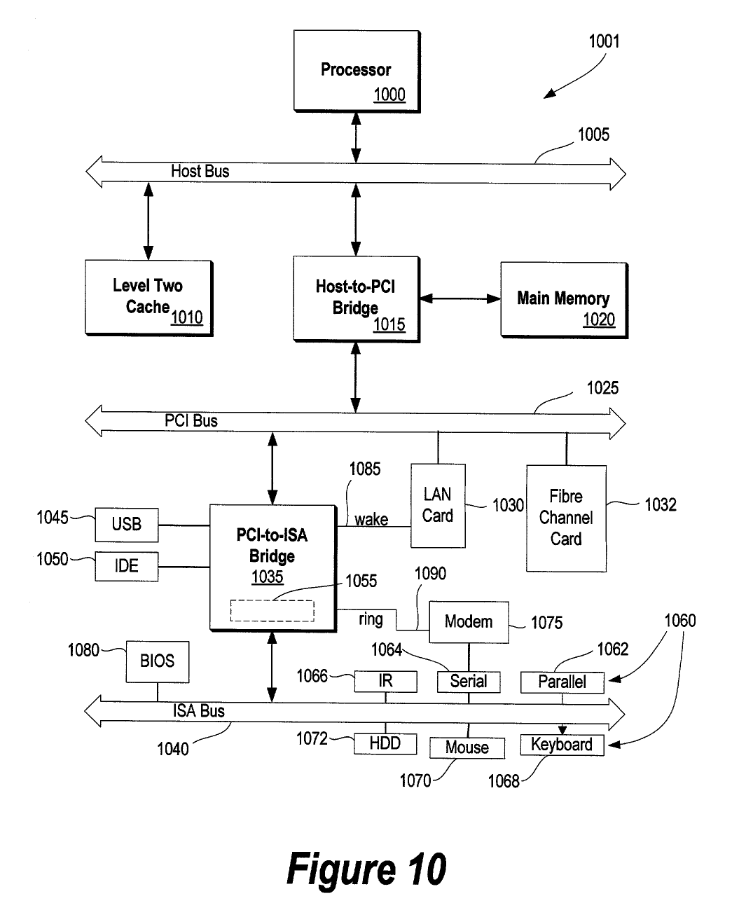

FIG. 10 illustrates information handling system 1001 which is a simplified example of a computer system capable of performing the operations described herein. Computer system 1001 includes processor 1000 which is coupled to host bus 1005. A level two (L2) cache memory 1010 is also coupled to the host bus 1005. Host-to-PCI bridge 1015 is coupled to main memory 1020, includes cache memory and main memory control functions, and provides bus control to handle transfers among PCI bus 1025, processor 1000, L2 cache 1010, main memory 1020, and host bus 1005. PCI bus 1025 provides an interface for a variety of devices including, for example, LAN card 1030. PCI-to-ISA bridge 1035 provides bus control to handle transfers between PCI bus 1025 and ISA bus 1040, universal serial bus (USB) functionality 1045, IDE device functionality 1050, power management functionality 1055, and can include other functional elements not shown, such as a real-time clock (RTC), DMA control, interrupt support, and system management bus support. Peripheral devices and input/output (I/O) devices can be attached to various interfaces 1060 (e.g., parallel interface 1062, serial interface 1064, infrared (IR) interface 1066, keyboard interface 1068, mouse interface 1070, fixed disk (HDD) 1072 coupled to ISA bus 1040. Alternatively, many I/O devices can be accommodated by a super I/O controller (not shown) attached to ISA bus 1040.

BIOS 1080 is coupled to ISA bus 1040, and incorporates the necessary processor executable code for a variety of low-level system functions and system boot functions. BIOS 1080 can be stored in any computer readable medium, including magnetic storage media, optical storage media, flash memory, random access memory, read only memory, and communications media conveying signals encoding the instructions (e.g., signals from a network). In order to attach computer system 1001 to another computer system to copy files over a network, LAN card 1030 is coupled to PCI bus 1025 and to PCI-to-ISA bridge 1035. Similarly, to connect computer system 1001 to an ISP to connect to the Internet using a telephone line connection, modem 1075 is connected to serial port 1064 and PCI-to-ISA Bridge 1035.

While the computer system described in FIG. 10 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for tracking air passenger travel progress, said method comprising:
receiving a passenger identifier corresponding to a passenger;
identifying a flight number corresponding to a flight on which the passenger is scheduled to fly;
retrieving near real-time flight data corresponding to the flight;
creating a message corresponding to the passenger based upon the retrieved flight data; and
transmitting the message to one or more communication addresses.

2. The method as described in claim 1 wherein at least one of the flight data is selected from the group consisting of an airport delay, a number of planes with EFC status, a changed flight plan, a flight cancellation, a changed ETA, a changed ETD, and a crossing of an air route traffic control center boundary corresponding to the flight.

3. The method as described in claim 1 further comprising:
reading one or more passenger notification triggers from a passenger profile corresponding to the passenger identifier, wherein the creating and transmitting steps are performed in response to determining that the flight data satisfies one or more of the triggers.

4. The method as described in claim 1 further comprising:
retrieving a seat assignment corresponding to the passenger;
identifying an air-phone nearest to the seat assignment;
retrieving a phone number corresponding to the air-phone, wherein one of the communication addresses is the phone number.

5. The method as described in claim 1 further comprising:
searching one or more flight manifests for the passenger identifier;
retrieving the flight number;
receiving the flight data corresponding to the flight number; and
comparing the flight data to a previously received set of flight data, wherein the creating and transmitting steps are performed in response to the comparison.

6. The method as described in claim 1 wherein at least one of the communication addresses is selected from the group consisting of a telephone number, a pager number, an email address, an air-phone on board the flight, a facsimile machine phone number, and an Internet web address.

7. The method as described in claim 1 further comprising:
sending a flight data request to an FAA ETMS system, the flight data request including the flight number; and
receiving an ETMS message from the FAA ETMS, wherein the ETMS message includes the flight data.

8. The method as described in claim 1 further comprising:
receiving a suspect name and identification data from a suspect data store, wherein the passenger identifier includes the suspect name;
searching one or more flight manifests for the suspect name;
retrieving the flight data in response to locating the suspect name in the flight manifests, wherein the message includes the suspect name, the identification data, and the flight data; and
identifying a law enforcement communication address corresponding to a destination that is included in the flight data, wherein one of the communication addresses includes the law enforcement communication address.

9. An information handling system comprising:
one or more processors;
a memory accessible by the processors;
a network interface connecting the information handling system to a computer network; and
a passenger tracking tool for tracking air passenger travel, the passenger tracking tool including:
means for receiving a passenger identifier corresponding to a passenger;
means for identifying a flight number corresponding to a flight on which the passenger is scheduled to fly;
means for retrieving near real-time flight data corresponding to the flight;
means for creating a message corresponding to the passenger based upon the retrieved flight data; and
means for transmitting the message to one or more communication addresses over the computer network.

10. The information handling system as described in claim 9 wherein at least one of the flight data is selected from the group consisting of an airport delay, a number of planes with EFC status, a changed flight plan, a flight cancellation, a changed ETA, a changed ETD, and a crossing of an air route traffic control center boundary corresponding to the flight.

11. The information handling system as described in claim 9 further comprising:
means for reading one or more passenger notification triggers from a passenger profile corresponding to the passenger identifier, wherein the means for creating and means for transmitting are performed in response to determining that the flight data satisfies one or more of the triggers.

12. The information handling system as described in claim 9 further comprising:
means for retrieving a seat assignment corresponding to the passenger;
means for identifying an air-phone nearest to the seat assignment;
means for retrieving a phone number corresponding to the air-phone, wherein one of the communication addresses is the phone number.

13. The information handling system as described in claim 9 further comprising:
means for searching one or more flight manifests for the passenger identifier;
means for retrieving the flight number;
means for receiving the flight data corresponding to the flight number; and
means for comparing the flight data to a previously received set of flight data, wherein the creating and transmitting steps are performed in response to the comparison.

14. The information handling system as described in claim 9 wherein at least one of the communication addresses is selected from the group consisting of a telephone number, a pager number, an email address, an air-phone on board the flight, a facsimile machine phone number, and an Internet web address.

15. The information handling system as described in claim 9 further comprising:
means for sending a flight data request to an FAA ETMS system, the flight data request including the flight number; and
means for receiving an ETMS message from the FAA ETMS, wherein the ETMS message includes the flight data.

16. The information handling system as described in claim 9 further comprising:
means for receiving a suspect name and identification data from a suspect data store, wherein the passenger identifier includes the suspect name;
means for searching one or more flight manifests for the suspect name;
means for retrieving the flight data in response to locating the suspect name in the flight manifests, wherein the message includes the suspect name, the identification data, and the flight data; and
means for identifying a law enforcement communication address corresponding to a destination that is included in the flight data, wherein one of the communication addresses includes the law enforcement communication address.

17. A computer program product stored in a computer operable media for tracking air passenger travel progress, said computer program product comprising:
means for receiving a passenger identifier corresponding to a passenger;
means for identifying a flight number corresponding to a flight on which the passenger is scheduled to fly;
means for retrieving near real-time flight data corresponding to the flight;
means for creating a message corresponding to the passenger based upon the retrieved flight data; and
means for transmitting the message to one or more communication addresses.

18. The computer program product as described in claim 17 wherein at least one of the flight data is selected from the group consisting of an airport delay, a number of planes with EFC status, a changed flight plan, a flight cancellation, a changed ETA, a changed ETD, and a crossing of an air route traffic control center boundary corresponding to the flight.

19. The computer program product as described in claim 17 further comprising:
means for reading one or more passenger notification triggers from a passenger profile corresponding to the passenger identifier, wherein the means for creating and means for transmitting are performed in response to determining that the flight data satisfies one or more of the triggers.

20. The computer program product as described in claim 17 further comprising:
means for retrieving a seat assignment corresponding to the passenger;
means for identifying an air-phone nearest to the seat assignment;
means for retrieving a phone number corresponding to the air-phone, wherein one of the communication addresses is the phone number.

21. The computer program product as described in claim 17 further comprising:
means for searching one or more flight manifests for the passenger identifier;
means for retrieving the flight number;
means for receiving the flight data corresponding to the flight number; and
means for comparing the flight data to a previously received set of flight data, wherein the creating and transmitting steps are performed in response to the comparison.

22. The computer program product as described in claim 17 wherein at least one of the communication addresses is selected from the group consisting of a telephone number, a pager number, an email address, an air-phone on board the flight, a facsimile machine phone number, and an Internet web address.

23. The computer program product as described in claim 17 further comprising:
means for sending a flight data request to an FAA ETMS system, the flight data request including the flight number; and
means for receiving an ETMS message from the FAA ETMS, wherein the ETMS message includes the flight data.

24. The computer program product as described in claim 17 further comprising:
means for receiving a suspect name and identification data from a suspect data store, wherein the passenger identifier includes the suspect name;
means for searching one or more flight manifests for the suspect name;
means for retrieving the flight data in response to locating the suspect name in the flight manifests, wherein the message includes the suspect name, the identification data, and the flight data; and
means for identifying a law enforcement communication address corresponding to a destination that is included in the flight data, wherein one of the communication addresses includes the law enforcement communication address.
